(19) United States
(12) Patent Application Publication
(10) Pub. No.: US 2026/0230323 A1
(43) Pub. Date: Aug. 6, 2026

(54) CHAINING OF TOKENS

(71) Applicant: Visa International Service Association, San Francisco, CA (US)

(72) Inventors: Premvir Singh, Greater Noida (IN); Punniyakotti Sabapathy, Thiruvannamalai (IN); Anandan Ethirkottai Sundararajan, Bangalore (IN)

(73) Assignee: Visa International Service Association, San Francisco, CA (US)

(21) Appl. No.: 19/147,852

(22) PCT Filed: Jan. 23, 2023
(86) PCT No.: PCT/US2023/061090

§ 371 Date: Jul. 14, 2025

(51) Int. Cl. H04L 9/32; H04L 9/08

(52) U.S. Cl. CPC H04L 9/3213; H04L 9/0869

(57) ABSTRACT

Embodiments can provide authentication tokens that are linked. Authentication tokens can be linked in such a way where the current authentication token can be determined by using a previous authentication token. Such embodiment can enable the server computer to authenticate the user even if the authentication token received by the client computer is not up to date.

### CROSS-REFERENCES TO RELATED APPLICATIONS

None.

### BACKGROUND

A client computer used by a user can receive an authentication token from a server computer after a user registers with an authentication server computer. When the user of the client computer subsequently needs to access a resource using the server computer, the client computer can use the authentication token to authenticate itself to the server computer. In some cases, after the server computer authenticates the client computer with an authentication token, the server computer creates and sends a new authentication token to the client computer for the next transaction conducted by the client computer.

However, if there is a disruption in the connection between the client computer and the server computer, the server computer may send the new authentication token to the client computer, but the client computer may not receive it. When the client computer attempts to conduct a subsequent transaction with the server computer and attempts to authenticate itself to the server computer, the client computer will send the previous authentication token to the server computer. The server computer, however, expects to receive the newly created token. Because the server computer did not receive the newly created token, the server computer will not be able to authenticate the client computer in the subsequent transaction, and will not allow the subsequent transaction to proceed.

Additionally, an authentication system can sometimes use different server computers that perform similar functions. This can be done to provide redundancy, reduce latency, etc. The different server computers periodically synchronize data so that client computers interacting with the system can have the same experience, regardless of the particular server computer with which it is currently interacting. If a client computer attempts to authenticate to different server computers in successive transactions within a short period of time, those server computers may not have had sufficient time to synchronize data. As a result, authentication attempts under such circumstances are likely to fail.

Embodiments of the disclosure address this problem and other problems individually and collectively.

### SUMMARY

One embodiment of the invention includes a method. The method comprises receiving, by a server computer, a first request message from a client computer; responsive to receiving the first request message, inputting a plurality of static data elements, and a first pseudorandom value into a token generator function to produce a first authentication token; transmitting, by the server computer to the client computer, a first response message comprising the first authentication token; receiving, by the server computer from the client computer, a second request message comprising the first authentication token; responsive to receiving the second request message, inputting the first authentication token into a pseudorandom number generator to obtain a second pseudorandom value; inputting the second pseudorandom value and the plurality of static data elements into the token generator function to obtain a second authentication token; and transmitting, by the server computer, a second response message comprising the second authentication token to the client computer, wherein the second authentication token is used for subsequent authentication with the server computer.

Another embodiment of the invention includes a server computer comprising: a processor; and a non-transitory computer readable medium comprising code, executable by the processor, for performing operations comprising: receiving a first request message from a client computer; responsive to receiving the first request message, inputting a plurality of static data elements, and a first pseudorandom value into a token generator function to produce a first authentication token; transmitting, to the client computer, a first response message comprising the first authentication token; receiving, from the client computer, a second request message comprising the first authentication token; responsive to receiving the second request message, inputting the first authentication token into a pseudorandom number generator to obtain a second pseudorandom value; inputting the second pseudorandom value and the plurality of static data elements into the token generator function to obtain a second authentication token; and transmitting a second response message comprising the second authentication token to the client computer, wherein the second authentication token is used for subsequent authentication with the server computer.

Another embodiment of the invention includes transmitting, by a client device to a server computer, a first request message, wherein the server computer inputs a plurality of static data elements and a first pseudorandom value into a token generator function to produce a first authentication token, and transmits, to the client computer, a first response message comprising the first authentication token; receiving, by the client device, the first authentication token; and transmitting, by the client device to the server computer, a second request message comprising the first authentication token, wherein the server computer inputs the first authentication token into a pseudorandom number generator to obtain a second pseudorandom value, inputs the second pseudorandom value and the plurality of static data elements into the token generator function to obtain a second authentication token, and transmits a second response message comprising the second authentication token to the client computer, wherein the second authentication token is used for subsequent authentication with the server computer.

Another embodiment of the invention includes a client device, comprising a processor; and a non-transitory computer readable medium, the non-transitory computer readable medium comprising code, executable by the processor to perform a method comprising: transmitting, by a client device to a server computer, a first request message, wherein the server computer inputs a plurality of static data elements and a first pseudorandom value into a token generator function to produce a first authentication token, and transmits, to the client computer, a first response message comprising the first authentication token; receiving, by the client device, the first authentication token; and transmitting, by the client device to the server computer, a second request message comprising the first authentication token, wherein the server computer inputs the first authentication token into a pseudorandom number generator to obtain a second pseudorandom value, inputs the second pseudorandom value and the plurality of static data elements into the token generator function to obtain a second authentication token, and transmits a second response message comprising the second authentication token to the client computer, wherein the second authentication token is used for subsequent authentication with the server computer.

A better understanding of the nature and advantages of embodiments of the invention may be gained with reference to the following detailed description and accompanying drawings.

### BRIEF DESCRIPTION OF THE DRAWINGS

FIG. 1 shows an authentication flow diagram.

FIG. 2 show a flow diagram of generating an authentication token.

FIG. 3 shows an authentication flow diagram which illustrates a failure to authenticate.

FIG. 4 shows a data flow diagram of generating a token according to embodiments.

FIG. 5 shows an authentication flow diagram that successfully authenticates using the token generated according to embodiments.

FIG. 6 shows a block diagram of a server computer according to some embodiments.

### DETAILED DESCRIPTION

Prior to discussing embodiments of the disclosure, some terms can be described in further detail.

A “user” may include an individual. In some embodiments, the user may be a cardholder, account holder, or consumer.

A “client device” may be a device that sends and receives communications from a server computer. In some embodiments, a client device can be a user device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “resource provider” may be an entity that can provide a resource such as goods, services, information, and/or access. Examples of resource providers includes merchants, data providers, transit agencies, governmental entities, venue, and dwelling operators, etc. A “merchant” may typically be an entity that engages in transactions and can sell goods or services, or provide access to goods or services.

An “authentication token” (auth token) can be a piece of information that verifies the identity of a user to a website, server, or anyone requesting verification of the user's identity. Authentication tokens can add an extra layer of security, along with having the additional benefit of being easily scalable and providing better access control. In terms of scalability, authentication tokens contain the data needed to verify a user's identity, and are stored locally on a user's device. Since each token can store user-specific data, auth tokens can tell a server what amount of access to give to a user, providing access control to the server distributing authentication tokens.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Embodiments can include the use of authentication tokens that are computationally linked. Authentication tokens in embodiments can be linked in such a way where a current authentication token can be determined by using a previous authentication token. Such embodiments can enable the server computer to authenticate a client device even if the authentication token received from the client device is not a current authentication token. For example, if the server computer receives a first authentication token from the client computer when expecting a second authentication token, the server computer can still authenticate the client computer by determining a second authentication token using the first authentication token. The server computer can then check whether the second authentication token determined by using the first authentication token matches with the second authentication token stored in its memory.

Embodiments of the invention improve system reliability, since a client computer can be authenticated, even if there was a problem providing a current authentication token to the client computer.

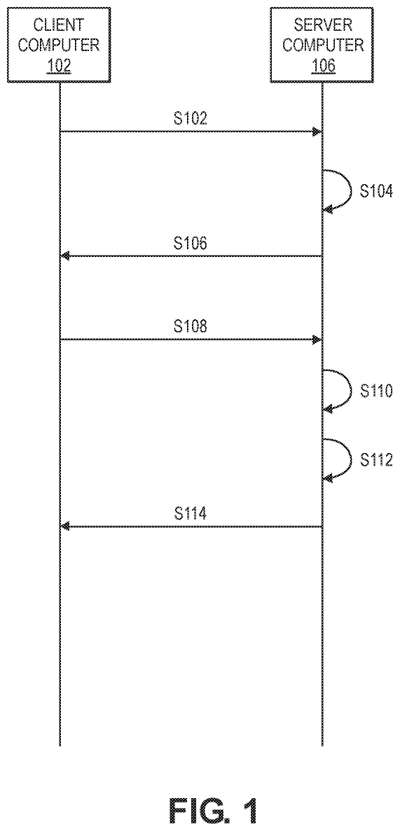

FIG. 1 shows an authentication flow diagram. A client computer 102 can authenticate itself to the server computer 106. In some cases, the client computer 102 may authenticate itself to the server computer 106 to access a resource available via the server computer 106. For example, the server computer 106 may provide access to a resource such as a good or service, secure data, or a secure location, after the server computer 106 authenticates the client computer 102.

The authentication flow diagram in FIG. 1 can comprise a registration phase and an authentication phase. The registration phase can comprise steps S102 to S106, while the authentication phase can comprise steps S108 to S114.

The devices and computers in the FIG. 1 and many of the subsequent Figures can communicate with one another using a communication network (not pictured), such as a cellular communication network or the Internet. However, it should be understood that such a communication network can take any suitable form, and may include any one and/or the combination of the following: a direct interconnection; the Internet; a Local Area Network (LAN); a Metropolitan Area Network (MAN); an operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers and devices in system 100 may be transmitted using a communication protocol such as, but not limited to, File Transfer Protocol (FTP); Hypertext Transfer Protocol (HTTP); Secure Hypertext Transfer Protocol (HTTPS); Secure Socket Layer (SSL), ISO (e.g., ISO 8583) and/or the like.

In step S102, a user using the client computer 102 can cause the client computer 102 to send a first request message comprising unique information relating to the user and the client computer 102. Such information may include device information about the client computer 102 (e.g., a phone number, IMEI number, manufacturer's serial number, etc.) and information about the user of the client computer 102 (e.g., a name, an account number, a user identifier such as a customer identifier). In some embodiments, the client computer 102 may wish to authenticate itself to the server computer 106 to access a resource available via the server computer 106. In some embodiments, the first request message may be characterized as an enrollment message.

In step S104, upon receiving the first request message from the client computer, the server computer 106 can verify the unique information sent by the client computer 102. For example, in a payment transaction, the server computer can verify that the user's account number and/or other personal information is authentic. The server computer 106 could also authenticate the client computer 102 or the user of the client computer 102 using an out-of-band authentication process such as a one-time password (OTP) authentication process. Upon a successful verification, the server computer 106 can generate a first authentication token based on static data and dynamic data. The server computer 106 can store the first authentication token in a database, and send the first authentication token to the client computer 102.

In step S106, the server computer 106 can generate and send a first response message comprising the first authentication token to the client computer 102. The server computer 106 can additionally allow the client computer to access a resource available via the server computer 106. The resource can be secure data, a secure location, or a good or service provided by an operator of the server computer 106. In the case where the resource to be obtained is a good or service, the server computer 106 can allow a transaction to proceed (e.g., the submission of a credit or debit card authorization request) if the user of the client computer 102 and the client computer 102 have been authenticated.

In step S108, the user of the client computer 102 may want to obtain a resource from the server computer 106. The client computer 102 can use the first authentication token to authenticate itself via the server computer 106. The client computer can do this by transmitting a second request message comprising the authentication token to the server computer 106.

In step S110, upon receiving the second request message, the server computer 106 can check whether the first authentication token received by the client computer 102 matches with the first authentication token in the database.

In step S112, after verifying that the two tokens match, the server computer 106 may provide the requested resource to the user of the client computer 102. The server computer 106 can also generate a second authentication token. The server computer 106 can generate the second authentication token using static data and dynamic data. The server computer 106 can then store the second authentication token in its database.

In step S114, the server computer 106 can send a second response message comprising the second authentication token to the client computer 102. The server computer 106 can additionally allow the client computer to access the resource available via the server computer. For a subsequent authentication, the client computer 102 can use the second authentication token to authenticate itself to the server computer 106 in a subsequent transaction.

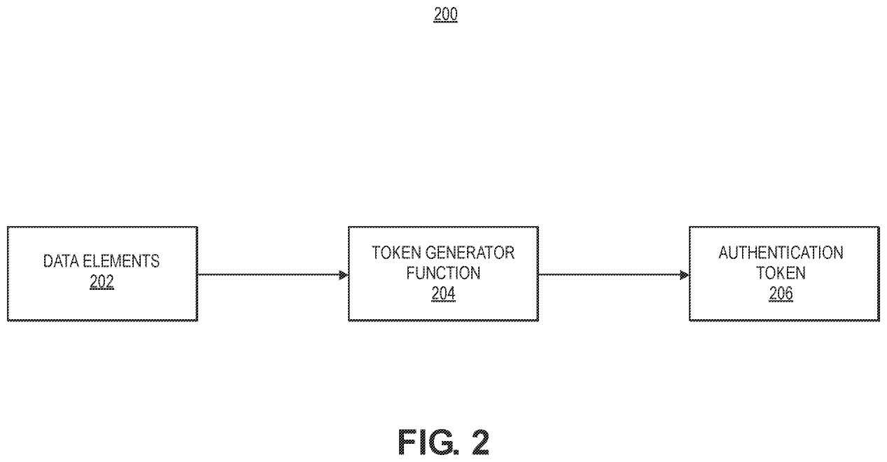

FIG. 2 shows a flow diagram of a server computer generating an authentication token using a prior method. The authentication token can input a plurality of data elements 202 into a token generator function 204 to determine an authentication token 206.

The plurality of data elements can be unique data elements of a user, data provided by a client computer, and other information. For example, when a user operating the client computer is authenticating for a payment transaction to the server computer, the plurality of data elements 202 can include static data such as the user's primary account number (or hash thereof), a unique identifier of the client computer, a user identifier, a merchant identifier, etc., and dynamic data elements such as a current time, etc. The static and dynamic data elements can be used to create unique authentication tokens for every transaction. Because the time of day used to generate a first authentication token and the time of day used to generate a second authentication token may be very different, the first authentication token and the second authentication token may not be linked or computationally related to each other.

The token generator function 204 can include any suitable function for altering data. For example, the token generator function 204 can has a cryptographic hash function such as SHA-1, or it can include a cryptographic function that uses a cryptographic key.

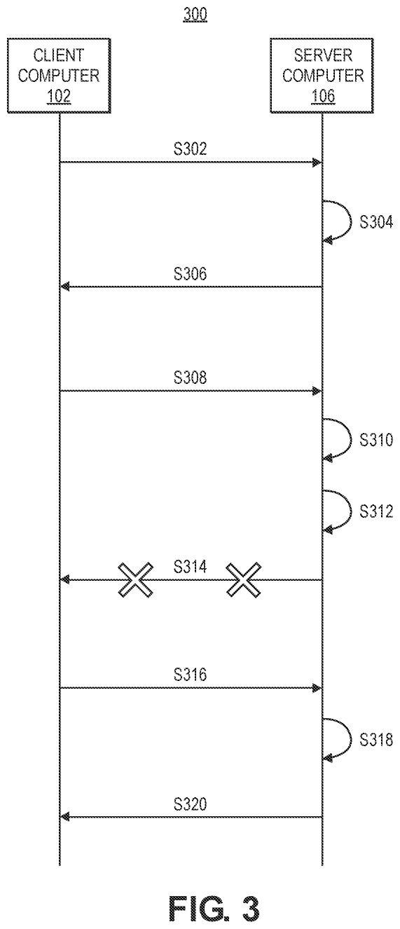

FIG. 3 shows an authentication flow diagram which illustrates a failure to authenticate. The authentication flow diagram can use a token generated from the method described in FIG. 2. The client computer 102 may authenticate itself to the server computer 106. The client computer 102 may authenticate itself to access a resource available via the server computer 106 such as a payment transaction, an account authentication, etc.

The authentication flow diagram can comprise a registration phase and authentication phases. The registration phase can comprise steps S302 to S306. A first authentication phase can comprise steps S308 to S314. A second authentication phase can comprise steps S316 to S320.

Steps S302 to S312 can be similar to steps S102 to S112 of the FIG. 1 with a first authentication token and a second authentication token being generated using the method described in FIG. 2. In step S314, when the server computer 106 stores the second authentication token and sends a second response message comprising the second authentication token to the client computer 102, there may be a network disruption that prevents the client computer 102 from receiving the second response message from the client computer 102.

In step S316, the client computer 102 may authenticate itself to the server computer 106 in a subsequent transaction to obtain a resource from the server computer 106. The client computer 102, because it did not receive the second authentication token from the server computer 106 due to the network disruption, will send the first authentication token to the server computer 106 to authenticate itself, rather than the second authentication token.

In step S318, the server computer 106 can check whether the first authentication token received from the client computer 102 matches with the second authentication token stored in the database of the server computer 106. Since the first authentication token does not match with the second authentication token, the server computer 106 does not authenticate the client computer 102.

In step S320, the server computer 106 can deny the user of the client computer 102 access to the requested resource. In this regard, the server computer 106 can send a third response message notifying the client computer 102 that it has not been authenticated.

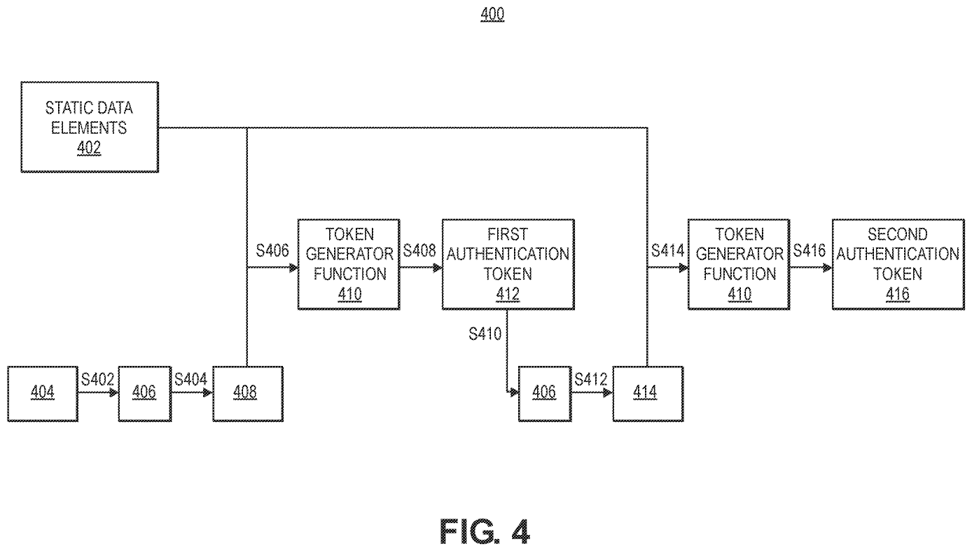

FIG. 4 shows a flow diagram of a server computer generating an authentication token according to embodiments. The authentication tokens generated in embodiments of the invention can be computationally linked (e.g., mathematically linked) so that a current authentication token can be determined by using a previous authentication token. For the data flow diagram of FIG. 4, a first authentication token 412 can be used as an input to generate a second authentication token 416.

Static data elements 402 can include unique data elements used to generate an authentication token. The static data can be unique data elements of a user, the client computer, and optionally a resource provider with which the user is interacting. Examples of static data elements include a user identifier, an account number such as primary account number, a resource provider identifier, a client computer identifier, or derivatives such as hashes thereof. These static data elements can be representative of a transaction that is taking place or will take place.

In step S402, an initialization vector 404 can be a seed and/or random data that can be input into a pseudorandom number generator 406. The initialization vector 404 can be some random string or number generated by the server computer. For example, the initialization vector 404 can be a 32 byte random string, which can be generated by a random number generator. In step S404, the pseudorandom number generator 406 can then output a first pseudorandom value 408.

In step S406, the static data elements 402 and the first pseudorandom value 408 can be input into a token generator function 410. In some embodiments, the token generator function 410 can be a cryptographic hash function that hashes a concatenated value comprising the static data elements 402 and the first pseudorandom value 408. In step S408, the token generator function 410 can output the first authentication token 412.

The second authentication token 416 can be generated using the first authentication token 412 and the static data elements 402. In step S410, the first authentication token 412 can be input into the pseudorandom number generator 406. In step S412, the pseudorandom number generator 406 can determine a second pseudorandom value 414. In step S414, the plurality of static data elements 402 and the second pseudorandom value 414 can be input into the token generator function 410. In step S416, the token generator function 410 can output the second authentication token 416.

Subsequent authentication tokens (e.g., third authentication token, fourth authentication token, etc.) can be generated by using the same method as shown in FIG. 4. All the authentication tokens can be derived from the same static data elements 402.

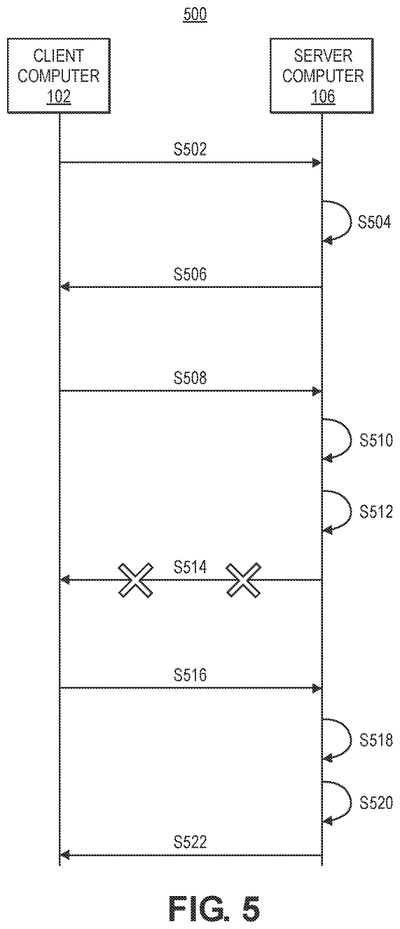

FIG. 5 shows an authentication flow diagram successfully authenticating a client computer using the authentication tokens generated using the method described with respect to FIG. 4. The flow shown in FIG. 5 shows successful authentication, even though an authentication token was sent by the server computer 106, but was never received by the client computer 102.

As in the previously described methods, the client computer 102 may authenticate itself to the server computer 106. The client computer 102 may authenticate itself to access a resource available via the server computer 106 such as a payment transaction, an account authentication, etc.

The client computer 102 can comprise a processor, and a non-transitory computer readable medium coupled to the processor. The non-transitory computer readable medium can comprise code, executable by the processor, for implementing a method comprising: transmitting, by the client computer to a server computer, a first request message, wherein the server computer inputs a plurality of static data elements and a first pseudorandom value into a token generator function to produce a first authentication token, and transmits, to the client computer, a first response message comprising the first authentication token; receiving, by the client computer, the first authentication token; and transmitting, by the client computer to the server computer, a second request message comprising the first authentication token, wherein the server computer inputs the first authentication token into a pseudorandom number generator to obtain a second pseudorandom value, inputs the second pseudorandom value and the plurality of static data elements into the token generator function to obtain a second authentication token, and transmits a second response message comprising the second authentication token to the client computer, wherein the second authentication token is used for subsequent authentication with the server computer. In some embodiments, the first and second authentication tokens may be stored in an SDK (software development kit) on the computer readable medium. The SDK may be an application that form part of a resource provider application (e.g., a merchant application), such that the resource provider application and the client computer 102 that stores it can authenticate to the server computer 106.

In step S502, a user using the client computer 102 can cause the client computer 102 to send a first request message comprising unique information relating to the user and the client computer 102. Such information may include device information about the client computer 102 (e.g., a phone number, IMEI number, manufacturer's serial number, etc.) and information about the user of the client computer 102 (e.g., a name, an account number, a user identifier such as a customer identifier). In some embodiments, the client computer 102 may wish to authenticate itself to the server computer 106 to access a resource available via the server computer 106.

In step S504, upon receiving the first request message from the client computer, the server computer 106 can verify the unique information sent by the client computer 102. For example, in a payment transaction, the server computer can verify that the user's account number and/or other personal information is authentic. The server computer 106 could also authenticate the client computer 102 or the user of the client computer 102 using an out-of-band authentication process such as a one-time password (OTP) authentication process. Upon a successful verification, the server computer 106 can generate a first authentication token based on static data and dynamic data. The server computer 106 can store the first authentication token in a database along with the static data elements, and send the first authentication token to the client computer 102. The first authentication token can be similar to the first authentication token 412 in FIG. 4.

In step S506, the server computer 106 can generate and send a first response message comprising the first authentication token to the client computer 102. The server computer 106 can additionally allow the client computer to access a resource available via the server computer 106. The resource can be secure data, a secure location, or a good or service provided by an operator of the server computer 106. In the case where the resource to be obtained is a good or service, the server computer 106 can allow a transaction to proceed (e.g., the submission of a credit or debit card authorization request) if the user of the client computer 102 and the client computer 102 have been authenticated.

In step S508, the client computer 102 can use the first authentication token to authenticate to the server computer 106 in a subsequent transaction. The client computer 102 may again authenticate itself to access a resource available via the server computer 106. For example, the client computer may use the first authentication token to authenticate itself to the server computer 106 to conduct another payment transaction to obtain a good or service from a resource provider such as an online merchant. The client computer 102 can transmit a second request message comprising the first authentication token to the server computer 106.

In step S510, upon receiving the second request message, the server computer 106 can check whether the first authentication token received by the client computer 102 matches the first authentication token stored in the database.

In step S512, upon verifying that the two authentication tokens match, the server computer 106 authenticate the client computer 102 and allow the user of the client computer 102 to obtain the requested resource. The server computer 106 can then generate a second authentication token (e.g., the second authentication token 416) by inputting a second pseudorandom value (e.g., 414 in FIG. 4) and the static data (e.g., 402 in FIG. 4) elements into a pseudorandom number generator (e.g., 406 in FIG. 4). The second pseudorandom value can be determined by inputting the first authentication token (e.g., 412 in FIG. 4) into the pseudorandom number generator (e.g., 406 in FIG. 4). The server computer 106 can then store the second authentication token in the database in conjunction with the static data elements.

In step S514, the server computer 106 can transmit a second response message comprising the second authentication token to the client computer 102. The second authentication token can be used by the client computer 102 for subsequent authentication with the server computer 106 in a subsequent transaction.

In some instances, the server computer 106 can try to send the second authentication token to the client computer 102, but there may be a network disruption that prevents the client computer 102 from receiving the second authentication token from the server computer 106.

In step S516, the client computer 102 may attempt to authenticate itself to the server computer 106 in another transaction such as to access secure data, a secure location, or a good or service. Because the client computer 102 did not receive the second authentication token from the server computer 106 due to the network disruption, the client computer 102 can send a third message comprising the first authentication token to the server computer 106. Since the server computer 108 attempted to send the second authentication token to the client computer 102 in step S514 and stored the same in the database, it expects to receive the second authentication token in third message.

In step S518, the server computer can check whether the first authentication token received by the client computer 102 matches with the second authentication token stored in the database of the server computer. Since the first authentication token does not match with the second authentication token, the server computer 106 can now determine whether the received first authentication token is linked to the second authentication token, thereby indicating that the client computer 102 is authentic. The server computer 106 can input the received first authentication token into a pseudo-random number generator (e.g., 406 in FIG. 4) to determine a second pseudorandom value (e.g., 414 in FIG. 4). The second pseudorandom value (e.g., 414 in FIG. 4) and the static data elements 402 can then be input into the token generator function (e.g., 410 in FIG. 4) to determine a second authentication token (e.g., 416 in FIG. 4). The server computer 106 can then match the second authentication token determined from the first authentication token to the second authentication token that is stored in the database. If the two tokens match, then the server computer can determine that the received first authentication token is linked to the second authentication token and the client computer 102 can be authenticated.

In step S520, if the two second authentication tokens match, then the server computer can generate a third authentication token using the second authentication token. The method illustrated in FIG. 4 can be used to generate the third authentication token (i.e., the “first authentication token 412” can be replaced with the second authentication token, and the “second authentication token 416” can be replaced with the third authentication token).

In step S522, the server computer 106 can send a third response message comprising the third authentication token to the client computer 102. The client computer 102 can use the third authentication token to authenticate the client computer 102 in a subsequent transaction.

In some embodiments, the server computer can set a limit with respect to the number of authentication tokens that can be directly linked to the current authentication token. For example, if the server computer generates a fourth authentication token, and attempts to send it to a client computer, then the server computer may only allow the prior third and second authentication tokens to authenticate the client device. The server computer may not allow a first authentication token, generated prior to the second authentication, to be used in an authentication when the current authentication token is a fourth authentication token. This is because authentication tokens that created many transactions prior to the current transactions, may not be reliable and cannot serve to authenticate the client computer.

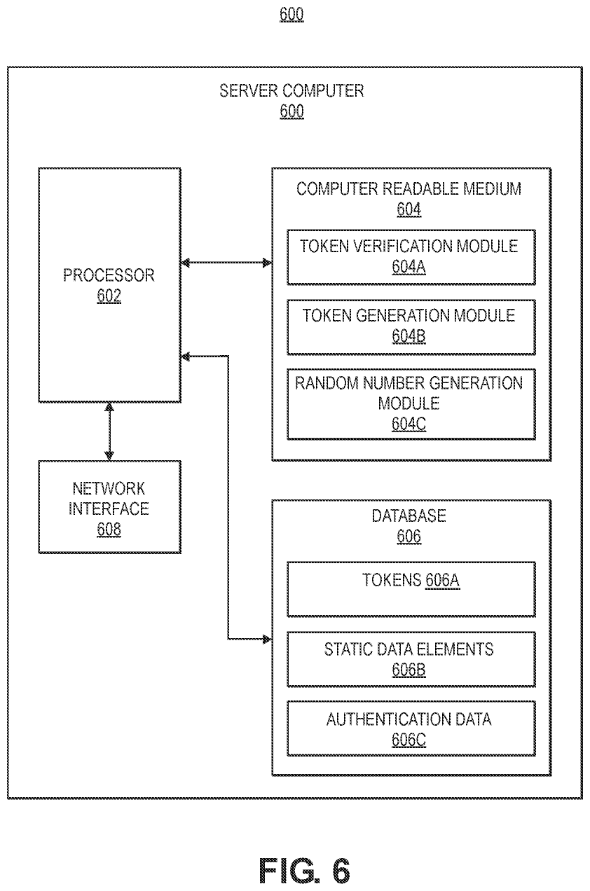

FIG. 6 shows a block diagram of a server computer 600 according to an embodiment. The server computer 600 may comprise a processor 602, which may be coupled to a computer readable medium 604, database 606, and a network interface 608.

The network interface 608 may include an interface that can allow the central server computer 200 to communicate with external computers. The network interface 608 may enable the server computer 600 to communicate data to and from another device (e.g., a card, an item provider computer, etc.). Some examples of the network interface 608 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 608 may include Wi-Fi™. Data transferred via the network interface 608 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 608 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 604 may comprise a number of software modules including a token verification module 604A, a token generation module 604B, and a random number generation module 604C.

The token verification module 604A may comprise code that can cause the processor 602 to verify whether the token received from a client computer matches with the token stored in the token storage 606A. The token generation module 604B may comprise code that can cause the processor 602 to generate an authentication token using the static data elements 606B and a previous authentication token stored in the token storage 606A. The random number generation module 604C (e.g., a pseudorandom number generator) may comprise code that can cause the processor 602 to generate a random number (e.g., a pseudorandom number) that can be used along with the static data elements 606B to determine an authentication token.

The computer readable medium 604 can also comprise code, executable by the processor 602, for performing operations comprising: receiving a first request message from a client computer; responsive to receiving the first request message, inputting a plurality of static data elements, and a first pseudorandom value into a token generator function to produce a first authentication token; transmitting, to the client computer, a first response message comprising the first authentication token; receiving, from the client computer, a second request message comprising the first authentication token; responsive to receiving the second request message, inputting the first authentication token into a pseudorandom number generator to obtain a second pseudorandom value; inputting the second pseudorandom value and the plurality of static data elements into the token generator function to obtain a second authentication token; and transmitting a second response message comprising the second authentication token to the client computer, wherein the second authentication token is used for subsequent authentication with the server computer

The database 606 may comprise a token storage 606A, a static data elements 606B, and authentication data 606C.

The token storage 606A can comprise the different authentication tokens that have been generated by the server computer 600. The static data elements 606B are described above and can be used to generate the authentication tokens. The authentication data 606C can be used to authenticate the users and/or the client computers that are in communication with the server computer 600.

Embodiments can have several advantages. One advantage is that the server computer can authenticate authentication tokens in situations where there may be network disruptions. When the server computer with the second authentication token receives the first authentication token from the client computer, the server computer can still authenticate the client computer by checking whether received first authentication token is linked to the second authentication token. If the second authentication token can be generated using the first authentication token, the server computer can verify the client computer and authenticate it.

Another advantage is that the server computer can authenticate in situations where there may be data synchronization delays. When the server computer with the second authentication token receives a third authentication token from the client computer, the server computer can still authenticate the client computer by checking whether the second authentication token in its database is linked to the received third authentication token. If the third authentication token can be generated using the second authentication token, the server computer can verify the client computer and authenticate it.

In some embodiments, the server computer 106 in FIG. 5 can be one server computer in a system comprising many server computers. The server computers in the system may synchronize data with each other. For example, one server computer can generate a first authentication token and may share the first authentication token with other server computers in the system. Such synchronization of data can occur when the system needs to provide redundancy or improve latency for users in different geographic areas.

It is apparent that the ability to “chain” the authentication tokens as described above, can allow different server computers in the same system that perform similar functions to authenticate client computers with authentication tokens, even if those server computers were unable to synchronize their data in a timely manner. Thus, embodiments of the invention allow systems with such server computers to function without disruption.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a server computer, a first request message from a client computer;
responsive to receiving the first request message, inputting a plurality of static data elements, and a first pseudorandom value into a token generator function to produce a first authentication token;
transmitting, by the server computer to the client computer, a first response message comprising the first authentication token;
receiving, by the server computer from the client computer, a second request message comprising the first authentication token;
responsive to receiving the second request message, inputting the first authentication token into a pseudorandom number generator to obtain a second pseudorandom value;
inputting the second pseudorandom value and the plurality of static data elements into the token generator function to obtain a second authentication token; and
transmitting, by the server computer, a second response message comprising the second authentication token to the client computer, wherein the second authentication token is used for subsequent authentication with the server computer.

2. The method of claim 1, wherein the second response message is not received by the client computer, and the method further comprises:
storing, by the server computer, the second authentication token in a database;
receiving, by the server computer, a third message comprising the first authentication token, when the server computer expects to receive the second authentication token;
determining, by the server computer, that the received first authentication token is linked to the second authentication token; and
responsive to determining that that the received first authentication token is linked to the second authentication token allowing the client computer to access a resource available via the server computer.

3. The method of claim 2, wherein determining that the received first authentication token is linked to the stored second authentication token comprises:
inputting, the received first authentication token into the pseudorandom number generator to obtain the second pseudorandom value; and
inputting the second pseudorandom value and the plurality of static data elements into the token generator function to obtain the second authentication token; and
determining that the obtained second authentication token to the stored second authentication token are equal, thereby determining that the received first authentication token is linked to the stored second authentication token.

4. The method of claim 1, wherein the static data elements comprise a device identifier for the client computer.

5. The method of claim 4, wherein the static data elements further comprise a user identifier for a user of the client computer.

6. The method of claim 5, wherein the static data elements further comprise a resource provider identifier associated with a resource provider computer which the client computer is interacting.

7. The method of claim 1, wherein the first request message and the second request message are received by the server computer via a resource provider computer.

8. The method of claim 1, further comprising:
generating, by the server computer, the first pseudorandom value by inputting an initialization vector into the pseudorandom number generator.

9. The method of claim 8, wherein the initialization vector is 32 bytes of random data.

10. The method of claim 1, wherein the server computer is a first server computer, and wherein the method further comprises:
synchronizing, by the first server computer, the first authentication token and the second authentication token with a second server computer, wherein the first server computer and the second server computer perform the same functions.

11. The method of claim 1, wherein the first request message is an enrollment request message comprising enrollment data of a user associated with the client computer.

12. The method of claim 1, wherein the client computer is a mobile phone.

13. The method of claim 12, wherein the first authentication token and the second authentication token are stored by an SDK on the client computer.

14. The method of claim 13, wherein the SDK is part of a resource provider application on the client computer.

15. A server computer comprising:
a processor; and
a non-transitory computer readable medium comprising code, executable by the processor, for performing operations comprising:
receiving a first request message from a client computer;
responsive to receiving the first request message, inputting a plurality of static data elements, and a first pseudorandom value into a token generator function to produce a first authentication token;
transmitting, to the client computer, a first response message comprising the first authentication token;
receiving, from the client computer, a second request message comprising the first authentication token;
responsive to receiving the second request message, inputting the first authentication token into a pseudorandom number generator to obtain a second pseudorandom value;
inputting the second pseudorandom value and the plurality of static data elements into the token generator function to obtain a second authentication token; and
transmitting a second response message comprising the second authentication token to the client computer, wherein the second authentication token is used for subsequent authentication with the server computer.

16. The server computer of claim 15, further comprising a random number generation module comprising the pseudorandom number generator and a token generation module for generating the first and second authentication tokens on the non-transitory computer readable medium.

17. The server computer of claim 15 further comprising:
a database for storing the first and second authentication tokens and the static data elements.

18. A method comprising:
transmitting, by a client computer to a server computer, a first request message, wherein the server computer inputs a plurality of static data elements and a first pseudorandom value into a token generator function to produce a first authentication token, and transmits, to the client computer, a first response message comprising the first authentication token;
receiving, by the client computer, the first authentication token; and
transmitting, by the client computer to the server computer, a second request message comprising the first authentication token, wherein the server computer inputs the first authentication token into a pseudorandom number generator to obtain a second pseudorandom value, inputs the second pseudorandom value and the plurality of static data elements into the token generator function to obtain a second authentication token, and transmits a second response message comprising the second authentication token to the client computer, wherein the second authentication token is used for subsequent authentication with the server computer.

19. The method of claim 18, wherein the second response message is not received by the client computer, and the server computer stores the second authentication token in a database, and the method further comprises:
transmitting, by the client computer to the server computer, a third message comprising the first authentication token, when the server computer expects to receive the second authentication token, and the server computer then determines that the received first authentication token is linked to the second authentication token, and allows the client computer to access a resource available via the server computer.

20. The method of claim 18, wherein the first and second request messages are received by the server computer from the client computer via a resource provider computer, wherein the client computer seeks to access a resource provided by the resource provider computer.
